(19) United States
(12) Patent Application Publication
(10) Pub. No.: US 2017/0073169 A1
(43) Pub. Date: Mar. 16, 2017

(54) VACUUM SYSTEM AND METHOD OF VACUUMING USING SAME

(71) Applicant: FILTRAR TECH INC., Saguenay (CA)

(72) Inventor: Jean-François TURCOTTE, St-Fulgence (CA)

(73) Assignee: FILTRAR TECH INC., Saguenay, QC (CA)

(21) Appl. No.: 15/122,584

(22) PCT Filed: Mar. 2, 2015
(86) PCT No.: PCT/CA2015/050154

§ 371 Date: Aug. 30, 2016

Related U.S. Application Data
(60) Provisional application No. 61/947,069, filed on Mar. 3, 2014.

(51) Int. Cl. B65G 45/10; B01D 46/00; B65G 45/22; B01D 46/02; B65B 35/00; B65G 15/00

(52) U.S. Cl. CPC B65G 45/10; B65B 35/00; B65G 15/00; B65G 45/22; B01D 46/02; B01D 46/0075; B01D 2279/55

(57) ABSTRACT

A vacuum system having a housing defining a collection chamber with a filter assembly mounted therein. The housing has a suction inlet and an exhaust port defined therein and in gas communication through the filter assembly. The vacuum system also includes a suction device having a motor operatively connected to a suction fan configured to generate a gas flow in the housing. The vacuum system also includes a rotor configured to engage the filter assembly in vibration upon rotation of the rotor. The vacuum system also includes a recirculation conduit having a valve configurable in a vacuum configuration preventing the gas flow from flowing through the recirculation conduit and a cleaning configuration allowing at least a portion of the gas flow to flow through the recirculation conduit to engage the rotor in rotation. A method of vacuuming using the vacuum system is also provided.

### CROSS-REFERENCE TO RELATED APPLICATIONS

This application claims priority under 35USC §119(e) of US provisional patent application 61/947,069 filed on Mar. 3, 2014, the specification of which is hereby incorporated by reference.

### FIELD OF THE INVENTION

The present invention relates to the field of vacuum systems. More particularly, it relates to a vacuum system configured to vacuum a section of a conveyor belt and return the vacuumed product on the conveyor belt, and to a method of vacuuming a section of a conveyor belt using same.

### BACKGROUND

Conveyors having a conveyor belt (or transport belt) are well known to move different materials, for example and without being limitative, in a factory, a plant or other industrial facility. In many cases, the material conveyed on the conveyor belt causes dust, debris or the like, derived from the conveyed material, to accumulate on the conveyor belt. Such debris can be undesirable for a plurality of reasons. For example, the accumulation of debris on the conveyor belt can cause premature failing of the drive of the conveyor, the conveyor belt, or other components of the conveyor. Moreover, the debris remaining on the conveyor belt, following a dispensing end thereof may subsequently fall on the floor under the conveyor belt, as the lower portion of the conveyor belt travels above the floor.

Consequently, it is known to use vacuum systems to vacuum a section of the conveyor belt, in order to remove the dust and debris accumulated thereon. However, known vacuum systems for vacuuming a conveyor belt of a conveyor tend to suffer from several drawbacks. For example, known vacuum systems normally collect the vacuumed material, inside a receptacle of the system, such as a collection chamber or an equivalent component. Such collection of the vacuumed material leads to the vacuumed material being removed from the conveyed material, thereby, resulting in an overall loss of material, which can be undesirable. Moreover, over time, accumulation of the vacuumed material in the vacuum system often leads to degradation of the performance of the vacuum system. Consequently, it is customary for operators to manually empty the receptacle of the vacuum system to remove the collected debris, following a certain operation time period, in order to ensure proper functioning of the vacuum system over time. Such a task can be time consuming and cumbersome.

In view of the above, there is a need for an improved vacuum system for a conveyor belt and a vacuuming method, which, would be able to overcome or at least minimize some of the above-discussed prior art concerns.

### SUMMARY OF THE INVENTION

According to a first general aspect, there is provided a vacuum system. The vacuum system comprises a housing defining a collection chamber, the housing having a suction inlet and an exhaust outlet, a filter assembly mounted in the collection chamber of the housing between the suction inlet and the exhaust outlet, the suction inlet and the exhaust outlet being in gas communication through the filter assembly, and a vibrator operatively connected to the filter assembly for imparting a vibration to the filter assembly.

In an embodiment, the vacuum system also comprises a recirculation conduit in gas communication with the exhaust outlet and the rotor, wherein the rotor is rotated by a gas flow circulating in the recirculation conduit. The recirculation conduit is configurable between a vacuum configuration preventing the gas flow from flowing through the recirculation conduit and a cleaning configuration allowing the gas flow to flow through the recirculation conduit. The recirculation conduit may include a valve for selectively configuring the recirculation conduit in the vacuum configuration and the cleaning configuration. The valve may be a flapper valve mounted at a junction of the recirculation conduit and the exhaust outlet, the flapper valve obstructing the recirculation conduit in the vacuum configuration and obstructing the exhaust outlet in the cleaning configuration. The rotor may include a turbine having a turbine input in gas communication with the recirculation conduit. The gas flow in the recirculation conduit may be outputted into the collection chamber.

In an embodiment, the rotor and the filter assembly may be operatively connected by a crankshaft. The rotor may be mounted proximate to the filter assembly, closer to the exhaust outlet along a housing gas flow path. The filter assembly may include an upper support plate operatively connected to the rotor, one or more filter bags each comprising a closed upper end and an open bottom end, the closed upper end being connected to the upper support plate, and a lower support plate in sealing engagement with an interior wall of the housing, the lower support plate comprising one or more apertures each connected to the open bottom end of the one or more filter bags. The one or more filter bags may be removably hung from the upper support plate. The one or more filter bags may be removably connected to the lower support plate.

In an embodiment, the vacuum system may also include a debris release unit in a lower section of the housing for releasing debris collected in the collection chamber. The debris release unit may include a hopper in communication with the collection chamber, and a release trap defined in the hopper and configured to release collected debris from the collection chamber. The release trap may include a flap, the flap being held in a closed configuration when the collection chamber is at a negative pressure relative to the pressure exterior to the vacuum system and is released into an open configuration when the collection chamber is at a positive pressure relative to the pressure exterior to the vacuum system. The release trap may include a flap, the flap being held in a closed configuration in a vacuum configuration and is pivoted to an open configuration in a cleaning configuration.

In an embodiment, the vacuum system may be mounted close to a conveyor belt and the release unit is configured to release collected debris onto the conveyor belt. The vacuum system may be mounted above a conveyor belt and the release unit is configured to release the collected debris onto the conveyor belt.

In an embodiment, the vacuum system may further includes a vacuum hose assembly including a vacuum hose connected to the suction inlet and a vacuum section mounted close to a section of the conveyor belt, operatively connected to the vacuum hose, and being configured to vacuum the section of the conveyor belt. The vacuum section may be mounted close to a section of an underside portion of the conveyor belt. The vacuum section may be mounted close to a section of a side portion of the conveyor belt. The vacuum system may also include a suction device including a suction fan and a motor operatively connected to the suction fan, the suction fan being mounted in the housing and creating a gas flow between the suction inlet and the exhaust outlet in an operative configuration. The suction fan may be mounted in an upper section of the housing, above the filter assembly and the vibrator.

According to another general aspect, there is also provided a vacuum system for a conveyor belt. The vacuum system comprises a housing defining a collection chamber, the housing having a suction inlet and an exhaust outlet defined therein; a filter assembly mounted in the collection chamber of the housing between the suction inlet and the exhaust outlet, the suction inlet and the exhaust outlet of the housing being in gas communication through the filter assembly, a suction device being configured to generate a gas flow in the collection chamber between the suction inlet and the exhaust outlet, and a debris return mechanism configurable in a vacuum configuration where debris vacuumed from the conveyor belt and contained in the gas flow is collected in the filter assembly and configurable in a cleaning configuration where the debris collected in the filter assembly is released therefrom and returned onto the conveyor belt.

In an embodiment, the debris return mechanism comprises a vibrator operatively connected to the filter assembly for imparting a vibration to the filter assembly when the debris return mechanism is in the cleaning configuration.

In an embodiment, the vibrator comprises a rotor mounted in the collection chamber, proximate to the filter assembly, the rotor imparting vibration to the filter assembly upon rotation thereof when the debris return mechanism is configured in the cleaning configuration.

In an embodiment, the vacuum system for a conveyor belt further comprises a recirculation conduit in gas communication with the exhaust outlet and the rotor, the recirculation conduit includes a recirculation output configurable to prevent the gas flow from flowing through the recirculation conduit when the debris return mechanism is configured in the vacuum configuration and configurable to allow at least a portion of the gas flow to flow through the recirculation conduit to engage the rotor in rotation when the debris return mechanism is configured in a cleaning configuration. The recirculation conduit may comprise a valve for selectively configuring the recirculation conduit to prevent the gas flow from flowing through the recirculation conduit and to allow at least a portion of the gas flow to flow through the recirculation conduit. The valve may be a flapper valve mounted at a junction of the recirculation conduit and the exhaust outlet, the flapper valve obstructing the recirculation conduit in the vacuum configuration and obstructing the exhaust outlet in the cleaning configuration. The rotor may include a turbine having a turbine input in gas communication with the recirculation conduit. The gas flow in the recirculation conduit may be outputted into the collection chamber. The rotor and the filter assembly may be operatively connected by a crankshaft. The rotor may be mounted proximate to the filter assembly, closer to the exhaust outlet along a housing gas flow path.

In an embodiment, the filter assembly comprises an upper support plate operatively connected to the rotor, one or more filter bags each comprising a closed upper end and an open bottom end, the closed upper end being connected to the upper support plate, and a lower support plate in sealing engagement with an interior wall of the housing, the lower support plate comprising one or more apertures each connected to the open bottom end of the one or more filter bags.

In an embodiment, the debris return mechanism further comprises a debris release unit comprising a hopper defined in a bottom section of the housing and in communication with the collection chamber, a release trap defined in the hopper and configured to release collected debris onto the conveyor belt when the debris return mechanism is configured in the cleaning configuration. The release trap may include a flap, the flap being held, in a closed configuration when the debris return mechanism is configured in the vacuuming configuration and being released into an open configuration when the debris return mechanism is configured in the cleaning configuration.

In an embodiment, the vacuum system for a conveyor belt further comprises a vacuum hose assembly including a hose connected to the suction inlet and a vacuum section connected to the hose and mounted close to a section of the conveyor belt and being configured to vacuum the section of the conveyor belt. The vacuum section may be mounted close to a section of an underside portion of the conveyor belt. The vacuum section may be mounted close to a section of a side portion of the conveyor belt. The suction fan may be mounted in an upper section of the housing, above the filter assembly and the vibrator.

According to yet another general aspect, there is also provided a method of vacuuming and cleaning a vacuum system. The method comprises the steps of: generating a gas flow in a collection chamber of a housing of a vacuum system, between a suction inlet and an exhaust outlet, the housing defining a collection chamber, configuring the vacuum system in a vacuum configuration wherein the gas flow flows between the suction inlet and the exhaust outlet, through a filter assembly, the gas flow being prevented from being recirculated into the collection chamber, and temporarily configuring the vacuum system in a cleaning configuration where at least a portion of the gas flow is recirculated into the collection chamber of the housing in order to release the debris collected in the filter assembly therefrom. The step of temporarily configuring the vacuum system in the cleaning configuration may comprise directing the gas flow to engage a rotor in rotation which in turn engages the filter assembly in vibration. The step of configuring the vacuum system in the vacuum configuration may comprise drawing gas including debris in proximity of a conveyor belt into the suction inlet and wherein temporarily configuring the vacuum system in the cleaning configuration comprises returning the debris collected in the filter assembly onto the conveyor belt.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a perspective view of a vacuum system for a conveyor belt, in accordance with an embodiment, and shown in combination with a corresponding conveyor belt.

FIG. 2 is a top plan view of the vacuum system and the conveyor belt of FIG. 1.

FIG. 3 is a right side elevation view of the vacuum system and the conveyor belt of FIG. 1.

FIG. 4 is a rear elevation view of the vacuum system and the conveyor belt of FIG. 1.

FIG. 5 is a front elevation view of the vacuum system and the conveyor belt of FIG. 1.

FIG. 6 is a partial cutaway view taken along lines 6-6 of FIG. 2 and showing an unsectioned filter assembly.

FIG. 7 is a bottom perspective and sectional view taken along lines 6-6 of FIG. 2, fragmented and enlarged, of the filter assembly.

FIG. 8 is a perspective sectional view taken along lines 6-6 of FIG. 2, enlarged, of an upper section of the vacuum system and the filter assembly, wherein the filter assembly is also sectioned.

FIG. 9 is a perspective view of the upper section of the vacuum system and the filter assembly of FIG. 6, wherein the filter assembly is also sectioned.

FIG. 10 is a sectional view taken along lines 10-10 of FIG. 2, fragmented, illustrating the recirculation conduit in a vacuum configuration.

FIG. 11 is a sectional view taken along lines 10-10 of FIG. 2, fragmented, illustrating the recirculation conduit in a cleaning configuration.

FIG. 12 is a flowchart of a method of vacuuming and cleaning a vacuum system in accordance with an embodiment.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the vacuum system for a conveyor belt and corresponding parts thereof consist of certain geometrical configurations as explained and illustrated herein all of these components and geometries are essential and thus should not be taken in their restrictive sense. It is to be understood, as also apparent to a person skilled in the art, that other suitable components and cooperation thereinbetween, as well as other suitable geometrical configurations, may be used for the vacuum system for a conveyor belt, as will be briefly explained herein and as can be easily inferred herefrom by a person skilled in the art. Moreover, it will be appreciated that positional descriptions such as “above”, “below”, “left”, “right”, “front” and “rear” and the like should, unless otherwise indicated, be taken in the context of the figures and should not be considered limiting.

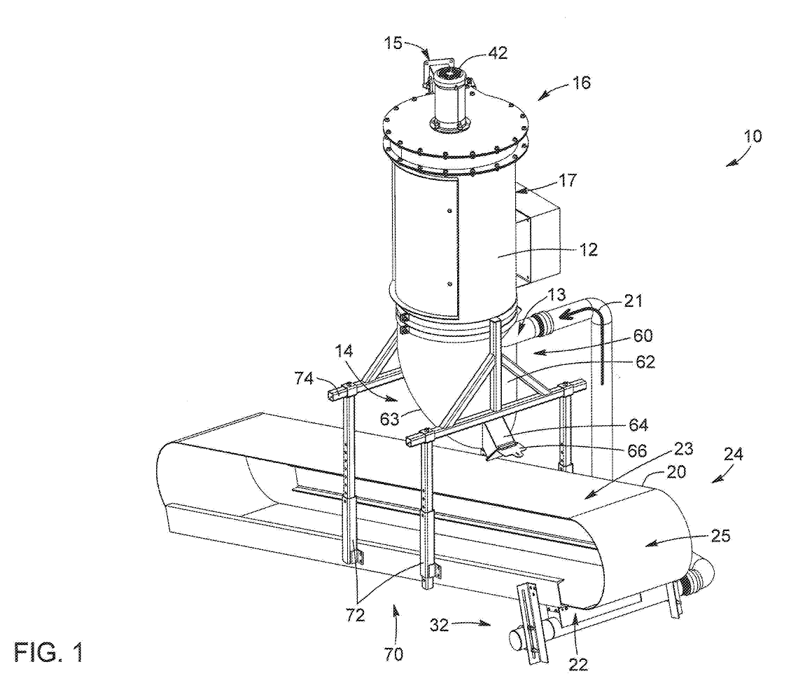

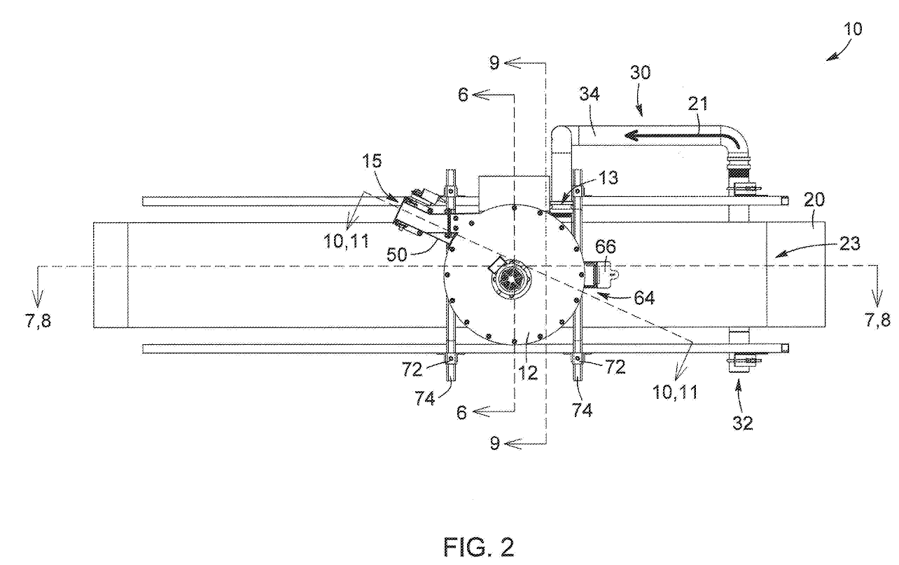

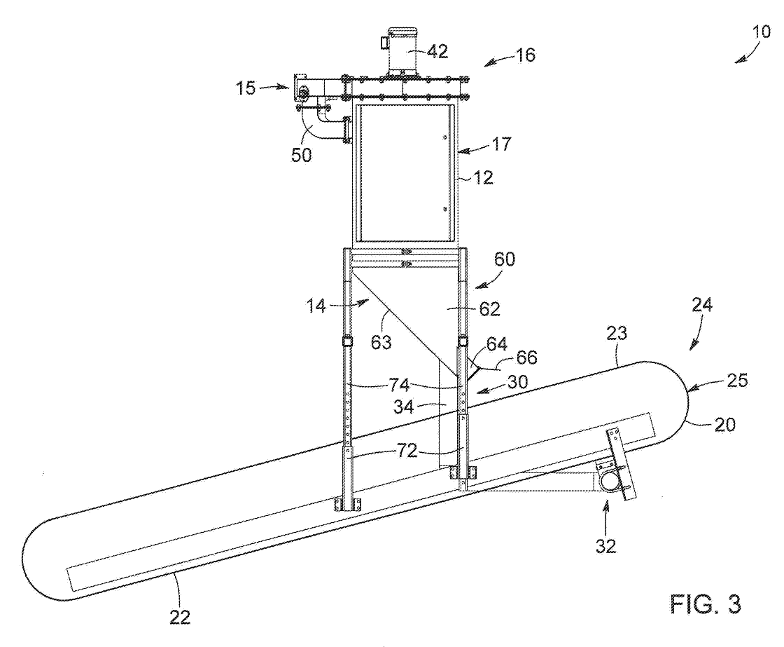

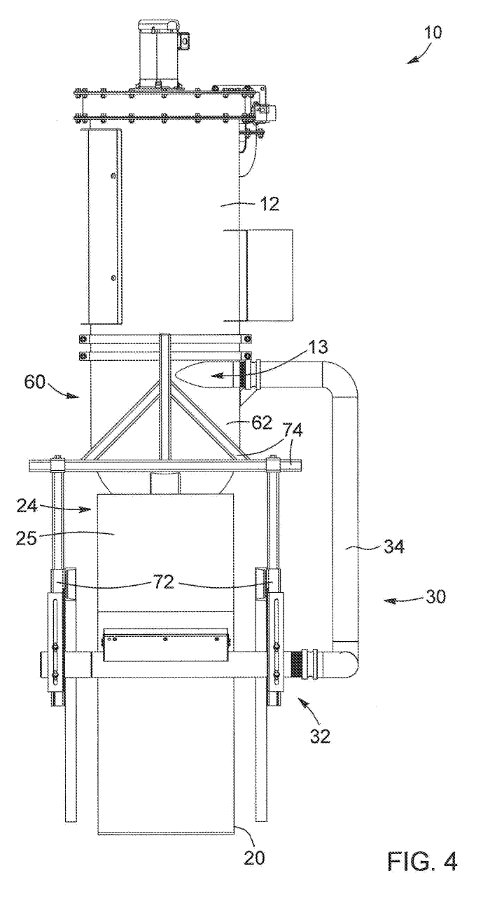

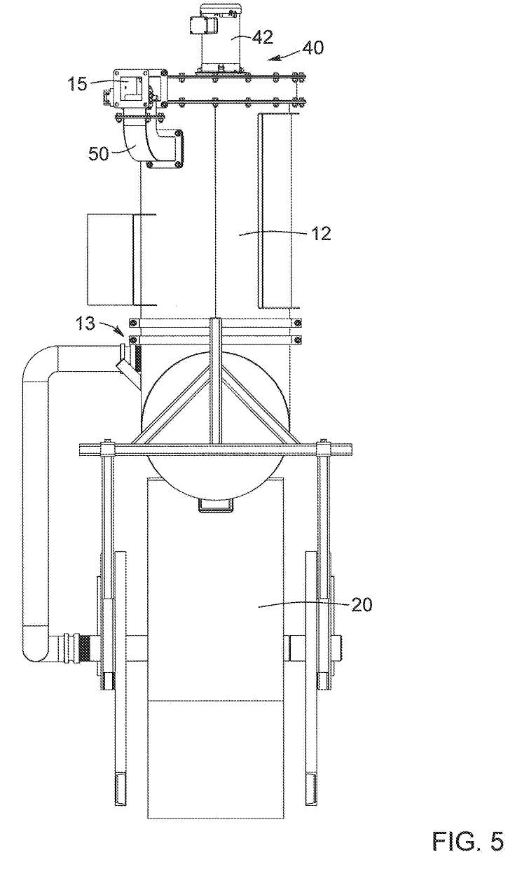

Referring generally to FIGS. 1 to 11, in accordance with one embodiment, there is provided a vacuum system 10 for vacuuming debris from a conveyor belt 20. The vacuum system 10 includes a housing 12 having a suction inlet 13 defined in a lower section 14 thereof and a gas exhaust outlet 15 defined in an upper section 16 thereof. The housing 12 also defines a collection chamber 17 between the suction inlet 13 and the exhaust outlet 15 where the collected debris is collected, temporarily maintained and selectively released, as will be described in more detail below. Of note, the term gas is used herein to may also include air or other forms of gas.

In an embodiment, the housing 12 of the vacuum system 10 is mounted over a section of the conveyor belt 20, using a housing support assembly 70. The housing support assembly 70 includes conveyor engaging members 72 mounted to a frame supporting the conveyor belt 20 and housing supporting members 74 connecting the conveyor engaging members 72 to the housing 12 and supporting the housing 12 of the vacuum system 10 over the conveyor belt 20. One skilled in the art will easily understand that the conveyor engaging members 72 can be connected to the conveyor frame using known connecting means such as, without being limitative, welding, soldering, riveting, nuts and bolts or the like. Similarly, the housing supporting members 74 can be engaged to the conveyor engaging members 72 and the housing 12 of the vacuum system 10 can be connected to the housing supporting members 74 using similar connecting means.

One skilled in the art would understand that, in an alternative embodiment, the vacuum system 10 can also be used independently of a conveyor belt, to vacuum other elements or articles. One skilled in the art would also understand that, in an embodiment where the vacuum system 10 is to vacuum a section of a conveyor belt 20, the configuration of housing 12 with respect to conveyor belt 20 of a conveyor can vary from the embodiment shown in the Figures. For example, the support members 70 can be configured to support the housing 12 of the vacuum system 10 adjacent to the conveyor belt 20.

Referring now to FIGS. 1 to 6, there is shown that, in an embodiment, the vacuum system 10 further includes a vacuum hose assembly 30 having a hose 34 with a port connected to the suction inlet 13 of the housing 12. The vacuum hose assembly 30 includes a vacuuming section 32 positioned proximate to a section of the conveyor belt 20 where a vacuum effect is desired. For example and without being limitative, in the illustrated embodiment, the vacuuming section 32 of the vacuum hose assembly 30 is positioned such as to vacuum and thereby remove debris remaining on a lower (or returning) section 22 of the conveyor belt 20, following a discarding end 24 thereof, where material conveyed on the conveyor belt 20 is discarded. One skilled in the art would understand that, in alternative embodiments, the vacuuming section 32 of the vacuum hose assembly 30 may be positioned proximate to a different section of the conveyor belt 20, distinct from the section shown in the illustrated embodiment. For example, the vacuuming section 32 of the vacuum hose assembly 30 may be positioned such as to remove debris remaining on a side section 25 of the conveyor belt 20 before debris would be allowed to fall to the ground. In an embodiment, the hose 34, connecting the vacuuming section 32 to the suction inlet 13, has a first port in communication with the vacuuming section 32 and a second port in communication with the suction inlet 13 of the housing 12.

In an embodiment, the vacuum system 10 also includes a debris release unit 60 in the lower section 14 of the housing 12. The debris release unit 60 is connected to a bottom end of the collection chamber 17. The debris release unit 60 includes a hopper 62 connected to the bottom end of the collection chamber 17 and in communication with the collection chamber 17, such as to receive debris falling from the collection chamber 17 therein. The hopper 62 has a release trap 64 in its lower section, which is configured to allow debris to be released from the hopper 62, by gravity for example, as will be explained in more detail below. In the illustrated embodiment, the hopper 62 has a bottom inclined wall 63 forming a chute towards the release trap 64. One skilled in the art would however understand that, in an alternative embodiment the hopper 62 could present a different configuration, such as, without being limitative, a funnel shape, forming a chute towards the release trap 64.

In an embodiment, the release trap 64 comprises a release flap 66 pivotally mounted to an upper portion of the release trap 64. The release flap 66 moves between a closed configuration and an open configuration, depending on the operation configuration of the vacuum system 10, as will be described in more detail below. As can be seen more clearly in FIG. 1, in the illustrated embodiment, the positioning of the housing 12 of the vacuum system 10 over the conveyor belt 20 results in the debris release unit 60 releasing the collected debris onto an upper (conveying) section 23 of the conveyor belt 20. Alternatively, in an embodiment where the positioning of the housing 12 of the vacuum system 10 is adjacent to the conveyor belt 20 results, the debris release unit 60 may be configured to extend from the bottom end of the collection chamber 17 to release the collected debris onto the upper section 23 of the conveyor belt 20.

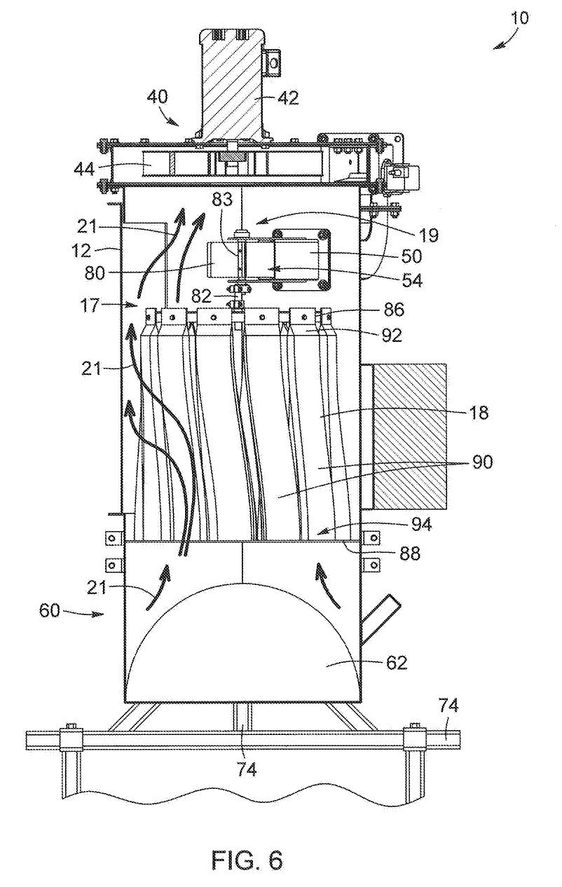

As can be seen more clearly in FIG. 6, in an embodiment, in order to collect debris, the collection chamber 17 defined in the housing 12 is provided with a filter assembly 18 mounted therein. The filter assembly 18 is positioned such that the suction inlet 13 and the exhaust outlet 15 of the housing 12 are in gas communication through the filter assembly 18, thereby resulting in the debris contained in a gas flow 21 flowing between the suction inlet 13 and the exhaust outlet 15 to be collected by the filter assembly 18. One skilled in the art will understand that, the filter assembly 18 can include different types of filters known in the art for filtering debris from a gas flow, for example a porous paper filter, polymeric filter, foam filter, woven and nonwoven filter, or textile filter.

In order to generate the gas flow 21 between the suction inlet 13 and the exhaust outlet 15, in an embodiment, the vacuum system 10 also includes a suction device 40. In an embodiment, the suction device 40 includes a motor 42 operatively connected to a suction fan 44. The suction fan 44 is illustratively mounted to the upper section 16 of the housing 12 and is in gas communication with the top end of the collection chamber 17 via a port 26. The suction fan 44 is driven in rotation by the motor 42 such as to create a vacuum effect in the collection chamber 17 by creating a negative pressure system therein, thereby drawing gas from the suction inlet 13 through the filter assembly 18, through the port 26 and expelling the drawn gas to atmosphere through the exhaust outlet 15. The above described vacuum effect thus generates a gas flow 21 in the housing 12, between the suction inlet 13 and the exhaust outlet 15. In an embodiment, the motor 42 is positioned outside of the housing 12 to the top end of the collection chamber 17 via the port 26, but one skilled in the art will understand that, in an alternative embodiment, the motor 42 can be internal to the housing 12, or the port 26 can be provided on the side of the collection chamber 17 or otherwise. A person skilled in the art will also understand that other configurations for creating a negative pressure system in the housing 12 such that gas is drawn from the suction inlet 13 and expelled via the exhaust outlet 15 are possible.

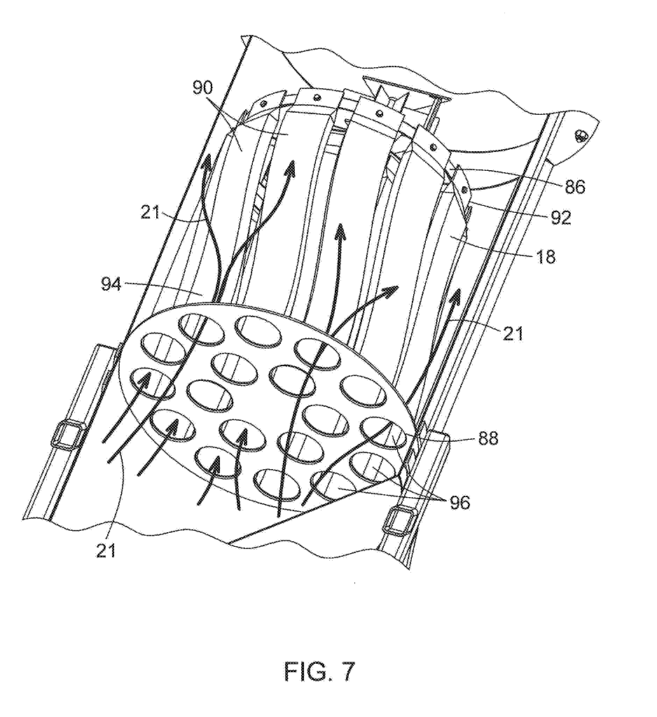

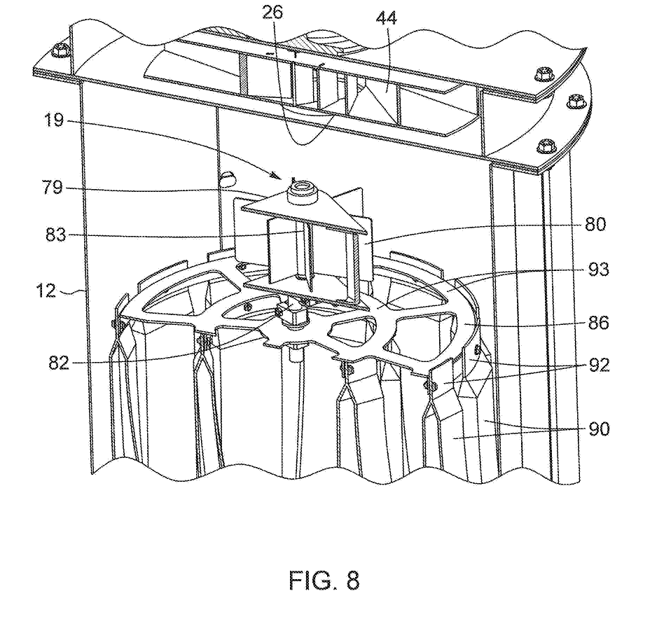

Referring now to FIGS. 7 and 8, there is shown that, in an embodiment, the filter assembly 18 illustratively comprises an upper support plate 86 and a lower support plate 88. The upper support plate 86 allows a plurality of filter bags 90 to be suspended and supported for example by hanging, under the force of gravity from closed upper ends 92 of the filter bags 90. The upper support plate 86 is illustratively provided in a circular shape consisting of two rows of concentric support rings 93 from which the filter bags 90 are suspended or hung. Illustratively, the upper support plate 86 has a diameter smaller than the diameter of the collecting chamber 17 to allow for the imbalanced and off axis rotation of the upper support plate 86 as will be described herein below. The filter bags 90 also include lower open ends 94 which are each in sealing communication with apertures 96 provided in the lower support plate 88. The lower support plate 88 illustratively abuts the side wall of the housing 12 in a sealing or near-sealing engagement such that, when the collecting chamber 17 is in a negative pressure state, the above-mentioned vacuum system 10 of the lower support plate 88 and the side wall of the housing 12 prevents gas flow 21 from being drawn there between, but is rather drawn to the path of least resistance through the apertures 96 into the lower open ends 94 and up into the filter bags 90 where the debris is maintained against the walls of the filter assembly 18, while gas flow 21 is allowed to pass through the filter bags 90 and towards the exhaust outlet 15. Debris is thus maintained against the walls of the filter bags 90 so long as there is a negative pressure state in the collecting chamber 17.

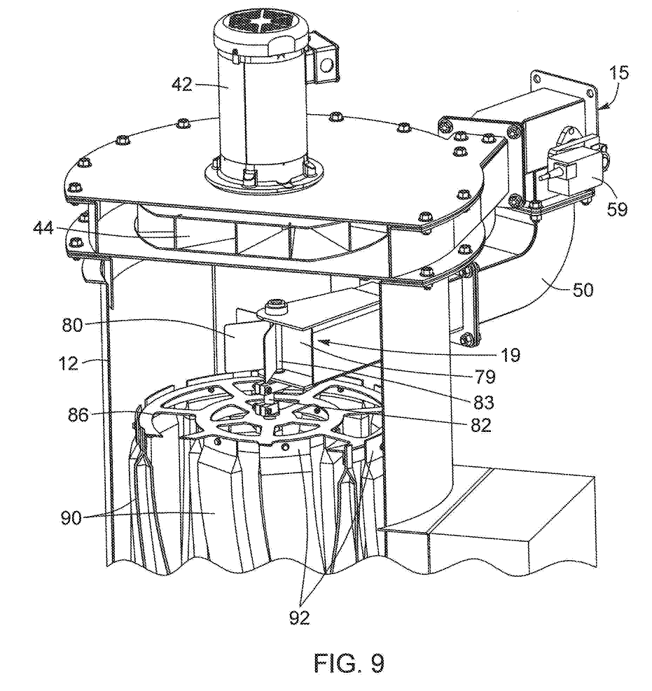

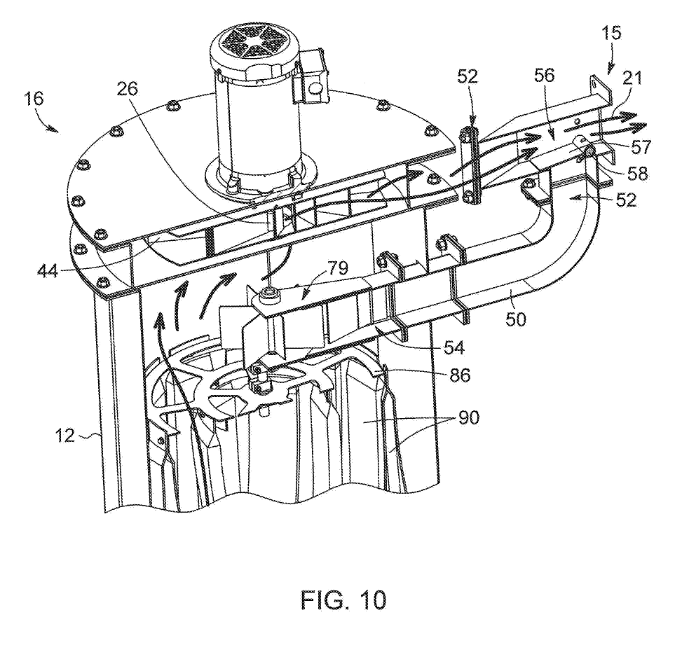

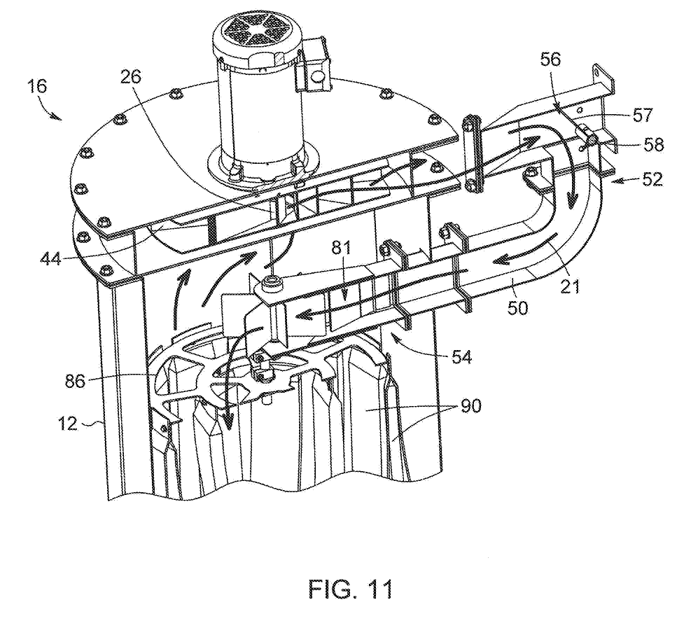

Referring now to FIGS. 8 and 9, there is shown that, in an embodiment, the vacuum system 10 further includes a vibrator, illustratively shown as a rotor 19, operatively connected to the filter assembly 18 for imparting a vibration to the filter assembly 18. The rotor 19 is illustratively located proximate to the filter assembly 18, for example the rotor 19 is illustratively located close to the exhaust outlet 15 along a gas flow path 21, and is operatively connected thereto such as to engage the filter assembly 18 in vibration, when the rotor 19 is activated, i.e. when the rotor 19 is engaged in rotation. In an embodiment, the rotor 19 includes a turbine 79 having a turbine input 81 (FIGS. 10 and 11) to receive a gas flow and a plurality of peripheral blades 80 mounted to a rotor shaft 83 and engageable in rotation by the gas flow 21 so as to impart a rotation of the rotor shaft 83. A vibration imparted to the filter assembly 18 will assist in removing debris drawn against the walls of the filter bags 90 during a negative pressure state in the collecting chamber 17 and which remain when the negative pressure state transitions to a positive pressure state. One skilled in the art would understand that, in alternative, embodiments, additional components could be used to connect the rotor 19 and the filter assembly 18, in order to impart or to increase the vibration of the filter assembly 18 when the rotor 19 is activated. In an embodiment, the rotor 19 is operatively connected to filter assembly 18 by an offset axial shaft 82 connected to the rotor shaft 83 to form a crankshaft configuration at a position beneath the rotor 19. Such a connection illustratively causes a vibratory imbalance in the rotation of the upper support plate 86 due to rotational imbalance of the upper support 86 relative to the rotor 19 which tends to shake the vibration of the filter assembly 18 and thus the filter bags 90. The vibration of the filter assembly 18 releases the debris collected in the filter bags 90. When released from the filter assembly 18, the debris falls in the release unit 60 under the influence of gravity. While the present invention has been described hereinabove by reference to an offset rotational axis configuration for causing vibratory imbalance and vibration in the filter assembly 18, a person skilled in the art will understand that other configurations for imparting a vibration to the filter assembly 18 are possible. For example, the rotor 19 may be connected to the lower support plate 88, or may be configured to provide a linear or non-linear vibration to the filter assembly 18.

In an embodiment, the vacuum system 10 further includes a recirculation conduit 50 having an inlet end 52 in gas communication with the output of the suction device 40 and with an outlet end 54 located proximate to the rotor 19, and which for example is in gas communication with the turbine input 81. The recirculation conduit 50 is also in gas communication with the exhaust outlet 15 such that the gas flow 21 flowing in the housing 12 is selectively in gas communication with the exhaust outlet 15 and the recirculation conduit outlet end 54, as will be explained in more detail below. The recirculation conduit 50 illustratively includes a valve 56 configurable to place the vacuum system 10 in a vacuum configuration or vacuum mode as illustrated in FIG. 10 whereby gas is directed from the collection chamber 17 to the suction fan 44, via the port 26, and expelled through the exhaust outlet 15. The valve 56 is also configurable to place the vacuum system 10 in a cleaning configuration or cleaning mode as illustrated in FIG. 11 whereby gas is directed from the collection chamber 17 to the suction fan 44, via the port 26, and the inlet end 52 to the outlet end 54 for directing gas flow 21 towards the turbine input 81. As illustrated, the valve 56 is illustratively a flapper valve including a flap 57 mounted about a rotatable shaft 58 rotatable within the recirculation conduit 50 by a torque imparted on the rotatable shaft 58 by an actuator 59 (FIG. 9), for example an electrical rotary actuator. In an embodiment, the transition between the vacuum configuration and the cleaning configuration of the vacuum system 10 is performed by the valve 56 blocking the recirculation conduit 50 to direct the gas flow 21 through the exhaust outlet 15 where it is vented to atmosphere in the vacuum configuration, and by the valve 56 only partially or not blocking the recirculation conduit 50 and thereby allowing at least a portion of the gas flow 21 from the inlet end 52 of the recirculation conduit 50 in the cleaning configuration. While a valve configuration has been illustrated herein for directing air flow from the collecting chamber 17 to the turbine input 81, other means for selectively directing the gas flow 21 between the exhaust outlet 15 and the turbine input 81 may be provided. Also, gas flow 21 may be directed directly against the filter assembly 18 through the recirculation conduit 50 to assist in the removal of the debris from the filter bags 90 without a vibration imparted the filter assembly 18 and without the use of a rotor 19.

The combination of the rotor 19, the recirculation conduit 50, and the debris release unit 60 may be referred to as a “debris return mechanism” as it allows the collected debris to be released from the filter assembly 18 and onto the conveyor belt 20, when the vacuum system 10 is in the cleaning configuration. One skilled in the art will however understand that, in an alternative embodiment, a different combination of components resulting in the vacuum system 10 being configurable in a vacuum configuration where debris contained in the gas flow 21 are collected in the filter assembly 18 and in a cleaning configuration where the debris collected in the filter assembly 18 are released therefrom, could be provided.

In a vacuum configuration or mode of the vacuum system 10, that is for example when the valve 56 is configured in the vacuum configuration, the valve 56 closes the recirculation conduit 50 and the gas flow 21 generated in the housing 12 by the suction device 40 is prevented from flowing through the recirculation conduit 50. Consequently, in the vacuum configuration, the gas vacuumed through the suction inlet 13 and into the housing 12 by the suction device 40 is driven into the collection chamber 17 and through the filter assembly 18, where dust and debris are collected, and the filtered gas is subsequently released through the exhaust outlet 15. The complete release of the filtered gas through the exhaust outlet 15 results in a negative pressure state in the collecting chamber 17 and the debris release unit 60 of the vacuum system 10. The above-mentioned negative pressure state causes the collected debris to be maintained against the walls of the filter assembly 18. The negative pressure state also causes the release flap 66 of the debris release trap 64 to be suctioned in the closed configuration, where it is held against the edge of the release trap 64, thereby sealing the debris release trap 64 closed.

In the cleaning mode of the vacuum system 10, that is when the valve 56 is configured in the cleaning configuration, the valve 56 opens the recirculation conduit 50 and at least a portion of the gas flow 21 generated in the housing 12 by the suction device 40 is allowed to flow through the recirculation conduit 50. Therefore, at least a portion of the vacuumed gas flow 21 is redirected back into the collection chamber 17 of the housing 12 through the recirculation conduit 50. Given that, as previously mentioned, the outlet end 54 of the recirculation conduit 50 is located proximate to the rotor 19, the flow of gas flow 21 in the recirculation conduit 50 results in the rotor 19 being engaged in rotation by the gas flow 21, which in turn causes the vibration of the filter assembly 18.

The recirculation of at least a portion of the gas flow 21 into the collection chamber 17 of the housing 12 also changes the negative pressure state in the collecting chamber 17 and the debris release unit 60 to a positive pressure state for example, which causes the release flap 66 of the debris release trap 64 to be released into the open configuration, by gravity for example. The combination of the transition of the negative pressure state in the collection chamber 17 to a positive pressure state and the vibration of the filter assembly 18 caused by the activated rotor 19 also results in the debris collected in the filter assembly 18 to be released therefrom. The released debris thus falls towards the hopper 62 of the debris release unit 60 positioned below the collecting chamber 17, under the influence of gravity, and exits the housing 12 through the debris release trap 64. In the illustrated embodiment, the debris is released onto an upper section 23 of the conveyor belt 20. One skilled in the art would understand that, in an alternative embodiment, the debris could however be released to a different location or into a receptacle such as, for example and without being limitative, a collection bin.

In an embodiment, the vacuum system 10 may be configured such that the cleaning mode is automatically triggered at predetermined time intervals. Alternatively, the cleaning mode may be manually triggered by a user when desired.

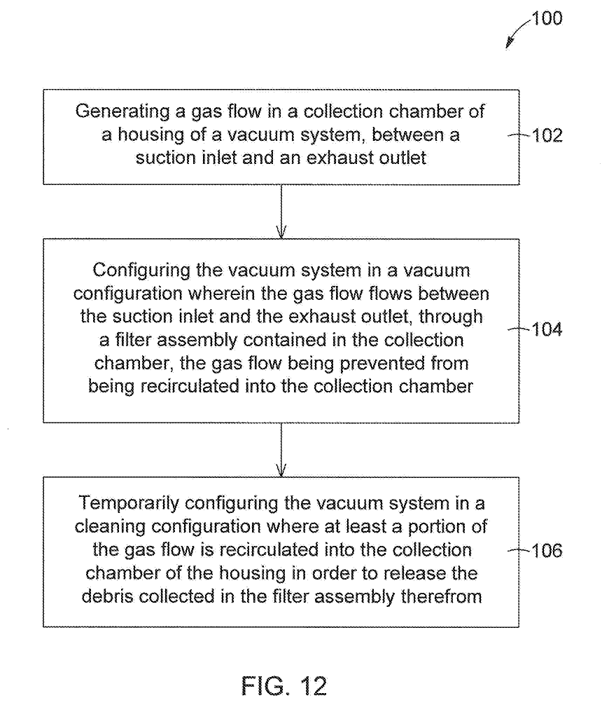

According to another aspect of the present invention, there is provided a method of vacuuming and cleaning a vacuum system 100. Examples of the steps of the method 100 are illustrated with reference to FIGS. 1 to 12. The method 100 includes the steps of generating a gas flow in a collection chamber of a housing of a vacuum system, between a suction inlet and an exhaust outlet, configuring the vacuum system in a vacuum configuration wherein the gas flow flows between the suction inlet and the exhaust outlet, through a filter assembly contained in the collection chamber, the gas flow being prevented from being recirculated into the collection chamber 104, and temporarily configuring the vacuum system in a cleaning configuration where at least a portion of the gas flow is recirculated into the collection chamber of the housing in order to release the debris collected in the filter assembly therefrom 106.

The step of temporarily configuring the vacuum system in the cleaning configuration 106 also includes directing the gas flow to engage a rotor in rotation which in turn engages the filter assembly in vibration.

The step of configuring the vacuum system in the vacuum configuration 104 further includes the step of drawing gas including debris in proximity of a conveyor belt and the step of temporarily configuring the vacuum system in the cleaning configuration 106 also includes the step of returning the debris collected in the filter assembly onto the conveyor belt.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications some to mind without significantly departing from the scope of the invention as defined in the appended claims.

1. A vacuum system comprising:
a housing defining a collection chamber, the housing having a suction inlet and an exhaust outlet;
a filter assembly mounted in the collection chamber of the housing between the suction inlet and the exhaust outlet, the suction inlet and the exhaust outlet being in gas communication through the filter assembly; and
a vibrator operatively connected to the filter assembly for imparting a vibration to the filter assembly.

2. The vacuum system of claim 1, wherein the vibrator comprises a rotor imparting vibration to the filter assembly upon rotation thereof.

3. The vacuum system of claim 2, further comprising a recirculation conduit in gas communication with the exhaust outlet and the rotor, wherein the rotor is rotated by a gas flow circulating in the recirculation conduit.

4. The vacuum system of claim 3, wherein the recirculation conduit is configurable between a vacuum configuration preventing the gas flow from flowing through the recirculation conduit and a cleaning configuration allowing the gas flow to flow through the recirculation conduit, wherein the recirculation conduit comprises a valve for selectively configuring the recirculation conduit in the vacuum configuration and the cleaning configuration, the valve being mounted at a junction of the recirculation conduit and the exhaust outlet, the valve obstructing the recirculation conduit in the vacuum configuration and obstructing the exhaust outlet in the cleaning configuration.

5.-6. (canceled)

7. The vacuum system of claim 3, wherein the rotor comprises a turbine having a turbine input in gas communication with the recirculation conduit and the gas flow in the recirculation conduit is outputted into the collection chamber.

8.-10. (canceled)

11. The vacuum system of claim 2, wherein the filter assembly comprises:
an upper support plate operatively connected to the rotor;
one or more filter bags each comprising a closed upper end and an open bottom end, the closed upper end being connected to the upper support plate; and
a lower support plate in sealing engagement with an interior wall of the housing, the lower support plate comprising one or more apertures each connected to the open bottom end of the one or more filter bags.

12.-13. (canceled)

14. The vacuum system of claim 1, further comprising a debris release unit in a lower section of the housing for releasing debris collected in the collection chamber.

15. The vacuum system of claim 14, wherein the debris release unit comprises:
a hopper in communication with the collection chamber; and
a release trap defined in the hopper and configured to release collected debris from the collection chamber.

16. The vacuum system of claim 15, wherein the release trap comprises a flap, the flap being held in a closed configuration when the collection chamber is at a negative pressure relative to the pressure exterior to the vacuum system and is released into an open configuration when the collection chamber is at a positive pressure relative to the pressure exterior to the vacuum system.

17. The vacuum system of claim 15, wherein the release trap comprises a flap, the flap being held in a closed configuration when the recirculation conduit is configured in a vacuum configuration and is pivoted to an open configuration when the recirculation conduit is configured in a cleaning configuration.

18. The vacuum system of claim 14, wherein the vacuum system is mounted close to a conveyor belt and the release unit is configured to release debris collected in the collection chamber onto the conveyor belt.

19. (canceled)

20. The vacuum system of claim 18, further comprising a vacuum hose assembly including:
a vacuum hose connected to the suction inlet; and
a vacuum section mounted close to a section of an underside portion of the conveyor belt, operatively connected to the vacuum hose, and being configured to vacuum the section of the conveyor belt.

21-22. (canceled)

23. The vacuum system of claim 1, further comprising a suction device including a suction fan and a motor operatively connected to the suction fan, the suction fan being mounted in an upper section of the housing, above the filter assembly and the vibrator, and creating a gas flow between the suction inlet and the exhaust outlet in an operative configuration.

24. (canceled)

25. A vacuum system for a conveyor belt, the vacuum system comprising:
a housing defining a collection chamber, the housing having a suction inlet and an exhaust outlet defined therein;
a filter assembly mounted in the collection chamber of the housing between the suction inlet and the exhaust outlet, the suction inlet and the exhaust outlet of the housing being in gas communication through the filter assembly;
a suction device being configured to generate a gas flow in the collection chamber between the suction inlet and the exhaust outlet; and
a debris return mechanism configurable in a vacuum configuration where debris vacuumed from the conveyor belt and contained in the gas flow is collected in the filter assembly and configurable in a cleaning configuration where the debris collected in the filter assembly is released therefrom and returned onto the conveyor belt.

26. The vacuum system for a conveyor belt of claim 25, wherein the debris return mechanism comprises a vibrator operatively connected to the filter assembly for imparting a vibration to the filter assembly when the debris return mechanism is in the cleaning configuration.

27. The vacuum system for a conveyor belt of claim 26, wherein the vibrator comprises a rotor mounted in the collection chamber, proximate to the filter assembly, the rotor imparting vibration to the filter assembly upon rotation thereof when the debris return mechanism is configured in the cleaning configuration.

28. The vacuum system for a conveyor belt of claim 27, further comprising a recirculation conduit in gas communication with the exhaust outlet and the rotor and includes a recirculation output configurable to prevent the gas flow from flowing through the recirculation conduit when the debris return mechanism is configured in the vacuum configuration and configurable to allow at least a portion of the gas flow to flow through the recirculation conduit to engage the rotor in rotation when the debris return mechanism is configured in a cleaning configuration.

29.-31. (canceled)

32. The vacuum system for a conveyor belt of claim 28, wherein the gas flow in the recirculation conduit is outputted into the collection chamber.

33.-34. (canceled)

35. The vacuum system for a conveyor belt of claim 27, wherein the filter assembly comprises:
an upper support plate operatively connected to the rotor;
one or more filter bags each comprising a closed upper end and an open bottom end, the closed upper end being connected to the upper support plate; and
a lower support plate in sealing engagement with an interior wall of the housing, the lower support plate comprising one or more apertures each connected to the open bottom end of the one or more filter bags.

36. The vacuum system for a conveyor belt of claim 25, wherein the debris return mechanism further comprises a debris release unit comprising:
a hopper defined in a bottom section of the housing and in communication with the collection chamber; and
a release trap defined in the hopper and including a flap and configured to release collected debris onto the conveyor belt when the debris return mechanism is configured in the cleaning configuration, the flap being held in a closed configuration when the debris return mechanism is configured in the vacuuming configuration and being released into an open configuration when the debris return mechanism is configured in the cleaning configuration.

37.-41. (canceled)

42. A method of vacuuming and cleaning a vacuum system, the method comprising the steps of:
generating a gas flow in a collection chamber of a housing of the vacuum system, between a suction inlet and an exhaust outlet;
configuring the vacuum system in a vacuum configuration wherein the gas flow flows between the suction inlet and the exhaust outlet, through a filter assembly, the gas flow being prevented from being recirculated into the collection chamber; and
temporarily configuring the vacuum system in a cleaning configuration where at least a portion of the gas flow is recirculated into the collection chamber of the housing in order to release debris collected in the filter assembly therefrom.

43. The method of claim 42, wherein temporarily configuring the vacuum system in the cleaning configuration comprises directing the gas flow to engage a rotor in rotation which in turn engages the filter assembly in vibration.

44. (canceled)
